(19) United States
(12) Patent Application Publication
(10) Pub. No.: US 2020/0130342 A1
(43) Pub. Date: Apr. 30, 2020

(54) BONDING AND DE-BONDING SYSTEM AND PROCESS

(71) Applicant: MICROSOFT TECHNOLOGY LICENSING, LLC, Redmond, WA (US)

(72) Inventors: Gregory Scott YODER, Sammamish, WA (US); Craig Daniel OWEN, Kirkland, WA (US)

(73) Assignee: MICROSOFT TECHNOLOGY LICENSING, LLC, Redmond, WA (US)

(21) Appl. No.: 16/177,347

(22) Filed: Oct. 31, 2018

(51) Int. Cl. B32B 43/00; B32B 7/12

(52) U.S. Cl. CPC B32B 43/006; B32B 2307/41; B32B 2457/10; B32B 7/12

(57) ABSTRACT

Adhesive devices for use with components of various systems, in particular electrical or thermally sensitive systems. The adhesive device includes a light-sensitive adhesive disposed adjacent to a light-transmissive material. The de-bonding process includes irradiating the light-transmissive material, thereby exposing any adjacent adhesive to the light as well. Because the adhesive material can include a bonding material that is configured to de-bond when exposed to the light, the disassembly of devices without risk to neighboring components is simplified.

### BACKGROUND

There is growing reliance on electronic devices, personal computers and other small devices. As a result, electronic devices are being used increasingly in tasks that lead to a need for regular maintenance, repair, and/or replacement of device components. For example, various electronic devices, such as cell phones, smartphones, laptop computers, tablet computers, e-readers, computer keyboards, electronic displays, and the like, may malfunction or a user may wish to upgrade or swap out component parts. Similarly, many mechanical devices can require periodic disassembly or repair. However, the internal components may be sensitive to changes in environment, and access or removal of a portion of a system can present a challenge to users of these devices.

As a specific example, current battery adhesives are often very tacky and difficult to remove. Users must insert the sub-assembly into a cold chamber for certain amount of time until the adhesive freezes and becomes brittle simply to effect a de-bonding of the battery from the system for repair or component reuse. Once brittle, the adhesion force between the battery-adhesive and/or system-adhesive is significantly reduced, and the battery is removed. Unfortunately, this process requires the system to be disassembled as much as possible in order to protect other thermally sensitive components, which significantly increases rework time and effort. Thus, there remain significant areas for new and improved ideas for the safe, effective, and easy bonding and de-bonding of components, particularly in electrical systems.

### SUMMARY

A physical assembly, in accord with a first aspect of this disclosure, includes a first opaque layer and a second opaque layer, and an adhesive device disposed between the first opaque layer and the second opaque layer. The adhesive device includes a light-transmissive layer comprising a material that is transmissive to a particular range of light wavelengths, and a first adhesive layer comprising a light-releasable adhesive, where the first adhesive layer is secured to a first surface of the light-transmissive layer.

A physical system, in accord with a second aspect of this disclosure, includes a first layer that is substantially opaque and a second layer configured to allow light to pass through the second layer. The physical system further includes a light de-bondable adhesive layer comprising a light-releasable adhesive. A first side of the light de-bondable adhesive layer is bonded to a surface of the first layer and a second side of the light de-bondable adhesive layer is bonded to a surface of the second layer. Furthermore, the physical system includes a light source configured to emit light. The light source is positioned such that light emitted by the light source passes through the second layer and contacts the light de-bondable adhesive layer.

A method of removing an opaque component that is bonded to an opaque portion of a physical assembly by a light de-bondable adhesive device, in accord with another aspect of this disclosure, includes orienting a light source such that light emitted from the light source will be directed toward an exposed end portion of a light-transmissive layer of the light de-bondable adhesive device. The method also includes irradiating the exposed portion with light emitted from the light source, in turn causing light to enter the light-transmissive layer and reflect between an uppermost surface of the light-transmissive layer and a lowermost surface of the light-transmissive layer along a length of the light-transmissive layer. In addition, the method includes irradiating, as a result of the reflection of light between the uppermost surface and the lowermost surface, a first adhesive surface of a light de-bondable adhesive layer of the light de-bondable adhesive device. The first adhesive surface is in contact with the uppermost surface of the light-transmissive layer, and so the irradiation causes a disruption of a plurality of bonds associated with the first adhesive surface. Furthermore, the method includes separating the opaque component from the opaque portion of the physical assembly.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A, 1B, and 1C illustrate an example of a system and method for de-bonding components from a substrate;

FIGS. 2A, 2B, and 2C illustrate an implementation of a de-bonding process where the bonding adhesive is disposed between a light channel and a substrate;

FIGS. 3A, 3B, and 3C illustrate an implementation of a de-bonding process where the bonding adhesive is disposed between a light channel and a component;

FIGS. 4A and 4B illustrate an implementation of a de-bonding process where both an upper surface and a lower surface of the bonding adhesive are de-bonded;

FIG. 5 is an implementation of a system that includes a light channel with a plurality of apertures;

FIG. 6 is an implementation of a system that includes a light channel disposed between two layers of bonding adhesive;

FIG. 7 is an implementation of a system that includes two light channels and two layers of bonding adhesive;

FIG. 8 is an implementation of a system that includes a bonding adhesive disposed between two light channels;

FIG. 9 is an implementation of a system that includes two light channels and three layers of bonding adhesive;

FIG. 10 is an implementation of a system that includes a bonding adhesive disposed adjacent to a substrate with a plurality of apertures;

FIG. 11 is an implementation of a system that includes a bonding adhesive disposed adjacent to a substrate including a transmissive material;

FIG. 12 is an implementation of a system that includes a bonding adhesive disposed adjacent to a component including a transmissive material;

FIG. 13 is an implementation of a system that includes a light channel embedded in a substrate;

FIG. 14 is an implementation of a system that includes a light channel embedded in a substrate;

FIG. 15 is an implementation of a method of and system for de-bonding;

FIG. 16 is an implementation of a method of and system for de-bonding where the light channel protrudes outward;

FIG. 17 is an implementation of a method of and system for de-bonding where the light channel protrudes outward;

FIG. 18 is an implementation of a method of and system for de-bonding where a light source is disposed behind the substrate;

FIG. 19 is an implementation of a method of and system for de-bonding where light is routed to the light channel using a reflective surface;

FIG. 20 is an implementation of a method of and system for de-bonding where light is routed to the light channel using a fiber optic material;

FIG. 21 is an implementation of a method of and system for de-bonding where light is routed to the light channel using a light box;

FIG. 22 is a flow chart presenting an implementation of a method of de-bonding a component from a physical assembly.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. In the following material, indications of direction, such as “top” or “left,” are merely to provide a frame of reference during the following discussion, and are not intended to indicate a required, desired, or intended orientation of the described articles.

The following description presents various implementations of adhesive devices for use with components of various physical systems, in particular electrical or thermally sensitive systems, as well as methods for bonding and de-bonding portions of such systems. In one example, the adhesive device can include a light-sensitive adhesive disposed adjacent to a light-transmissive material, also referred to herein as a light channel or waveguide. In some implementations, the de-bonding process includes the exposure of such a light channel to light, thereby exposing any adjacent adhesive to the light as well. The adhesive can include a bonding material that is configured to ‘de-bond’ (i.e., its adhesive bonds are compromised or disrupted) when exposed to the light for a period of time. Such a system permits users to disassemble devices and remove components without risk to neighboring components or necessitating the removal of adjoining components, reducing the overall likelihood of damage to the device. Furthermore, sensitive components can now be effectively removed from the system with minimal disruption or disturbance of surrounding components, and significantly reduce rework time. Various arrangements of this system will be described that can each facilitate an effective and safe process for separation of components through the application of light and offer significant benefits across the use of a wide range of physical systems.

In one implementation, a physical system or assembly includes any physical arrangement, machine, tool, instrument, or electrical or mechanical apparatus, and/or set of components that include at least two distinct and separate objects or parts that have been (removably) secured together. The disclosed systems are particularly of value in the context of electronic, electrical, and/or mechanical systems, which are typically sensitive to changes in environment.

As noted earlier, traditional de-bonding techniques have utilized a cold chamber to compromise the bond between components. In the present disclosure, the de-bonding techniques are simplified by the inclusion of light-releasable or light de-bondable adhesives. In one implementation, a light-releasable adhesive material or light de-bondable adhesive (LDA) material refer to adhesive instruments that lose some or all of their adhesive properties upon exposure to specific types of light for a period of time. Typically, following the requisite light irradiation, such tapes will lose 90% or more of their adhesion strength. In different implementations, the LDA can be sensitive and releasable upon exposure to one or more wavelengths that fall within the electromagnetic spectrum, including but not limited to ultraviolet (UV) light, infrared (IR) light, visible light, microwaves, gamma rays, X-rays, and radio waves.

UV-releasable adhesives or UV-de-bondable adhesives can refer to adhesives that have reduced adhesion when exposed to UV light. Some examples of flexible tapes with UV releasable adhesives that might be used with implementations described herein include Adwill D-Series UV curable dicing Tape™ from LINTEC Corp.® of Japan; Furukawa UV-Tape™ from The Furukawa Electric Co, Ltd.® of Japan; the Axon® PM series of UV-releasable tapes; and Wacker UV-Tape™ available from Dou Yee Enterprises® of Singapore. UV releasable adhesives are also sometimes commonly called UV curable adhesives, leading to possible confusion between adhesives whose adhesion decreases on exposure to UV light and adhesives whose adhesion increases on exposure to UV light. Furthermore, a ‘UV curable’ adhesive means one whose adhesion increases on exposure to UV light, and a ‘UV releasable’ or ‘UV de-bondable’ adhesive means one whose adhesion decreases on exposure to UV light.

In another implementation, UV2005N™ DWELL® protective film with UV-off Adhesive can be used, which structure includes a PET film, a UV-off adhesive, and a PET liner. The UV2005N™ product has an approximate thickness of 50 micrometers, and a holding power of approximately less than or equal to 1 mm at 80° C. and 1 kg. In addition, the UV2005N™ product's 180° peel strength is about 1000 gf/inch before UV treatment; after 20 minutes of exposure to 365 nm UV light treatment (until the accumulated surface energy reaches approximately 1000 mJ/cm²) the peel strength diminishes to approximately 20 gf/inch. Thus, after UV de-bonding, the peel force is generally less than 20 gf/25 mm; in other words, the adhesive may be nearly completely non-functional following UV light treatment or irradiation. In contrast, prior to the UV treatment, the initial peel force is greater than 600 gf/25 mm, ensuring the surfaces covered by the adhesive will be secured even at the borders or edges. Furthermore, this type of adhesive has little to no residue risk. In other implementations, SEKISUI® Self-Releasable Protective Tape SELFA-MP™ may instead be utilized. However, it should be understood that in different implementations, any other UV-releasable tape may be used, as well as other types of light-releasable tapes.

The reader may appreciate that the use of light to disassemble or otherwise degrade a bond is attractive because such a stimulus can be applied locally and often more readily than other stimuli, for example in places that are difficult to access, in situations where heat transfer is inadequate, or where the application of other stimuli could be harmful to the system environment, such as in biomedical or electrical applications. It can further be appreciated that such an approach can be of use if the site permits access to light. In other words, because many components are arranged in a way that hinders visual or optical exposure of the bonding adhesive, the most attractive and effective system will also offer a means of coupling the light to the bonding surface of the adhesive.

In different implementations, the adhesive devices described herein may further include an optically transmissive layer that will be disposed directly adjacent to the light-releasable adhesive. When exposed to light, photons can enter the optically transmissive carrier material (also referred to herein as a “light channel”, “optical channel”, “light transmissive layer”, or “waveguide”), bounce between the internal surfaces of the light channel, and become absorbed by the light-releasable adhesive. If the light is of the appropriate wavelength(s), and is absorbed for the requisite period of time, the adhesive strength becomes compromised or disrupted, eventually resulting in adhesive failure and the easy removal of the components that were bonded together via the light-sensitive adhesive. As will be described in greater detail below, the following systems will include provisions to ensure the ready access of light onto (or through) the adhesive.

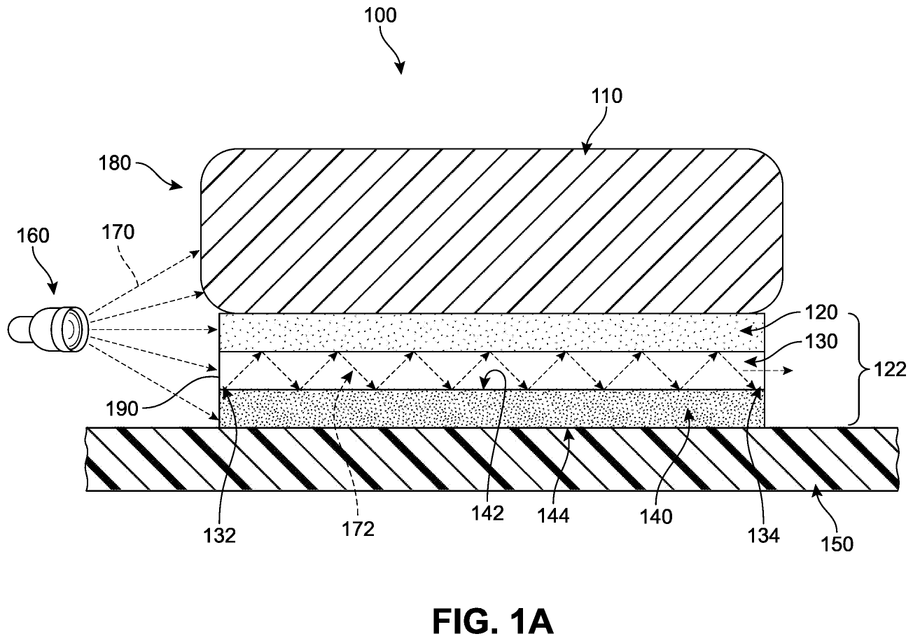

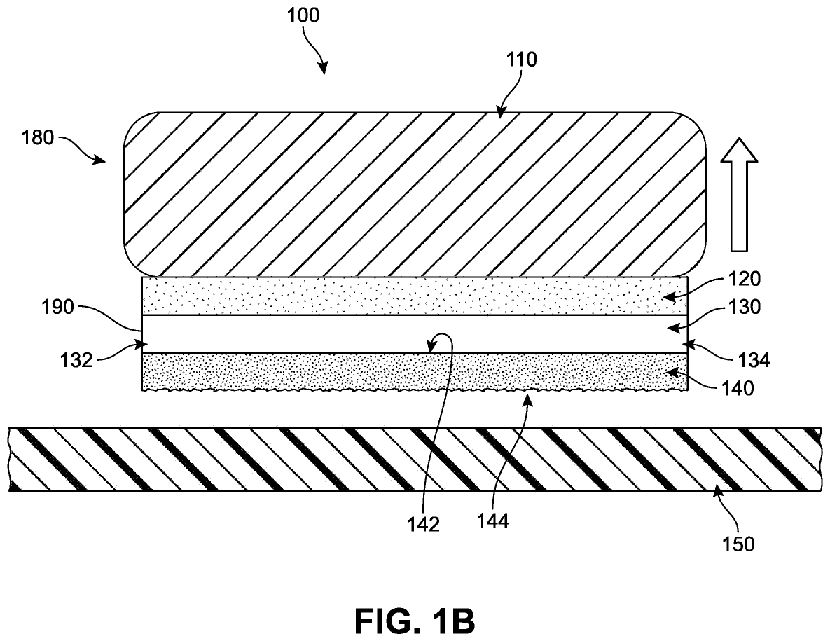

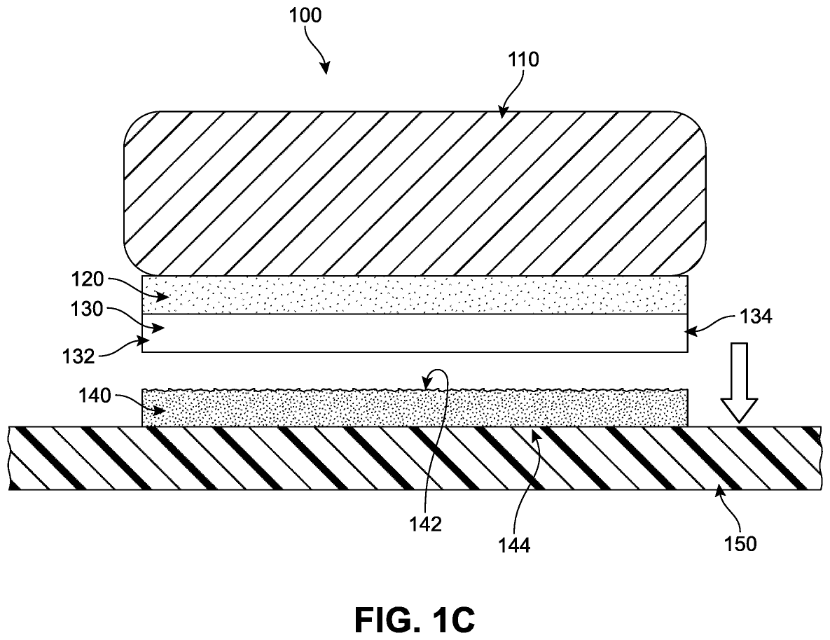

As a general overview, FIGS. 1A, 1B, and 1C present an implementation of a system and method of de-bonding components using a light channel and light-sensitive adhesive. In FIGS. 1A-1C, a first system 100 is depicted across a sequence of three drawings. The first system 100 includes a first component 110, a first general adhesive layer (“first adhesive layer”) 120, a first light-transmissive layer (“LTL”) 130, a first light de-bondable adhesive (“LDA”) layer 140, and a first substrate 150. For purposes of clarity, the term ‘substrate’ should be generally understood to refer to a region of a system that is supporting or is being secured or bonded to the component. Thus, references to the substrate in the drawings and the description are intended to point to only a portion of a larger apparatus or instrument(s). In one implementation, a substrate may be a portion of the housing, external surface, or enclosure of another component of the physical system while in other implementations a substrate can refer to a portion of another component of the larger system. In addition, the general adhesive layer can include any commonly known adhesive types, including but not limited to pressure sensitive adhesives, epoxies, acrylics, urethane acrylates, cyanoacrylates, light-curable acrylics, polyurethanes, silicones, resins, electrically conductive adhesives, ultraviolet-curing adhesives, thermally conductive adhesives, polymides, and other adhesives used in electronics manufacturing and mechanical engineering.

As will be discussed in greater detail below, in different implementations, the system includes a thin glass sheet (or other type of optically transmissive material) that is coated on both sides with a layer of adhesive, thereby producing a double-sided ‘tape’ with an inner glass carrier. At least one coating includes an adhesive that is light-releasable. For purposes of clarity, this tape assembly and/or portions of the tape assembly will be referred to as an adhesive device (see, for example, a first adhesive device (“first device”) 122 in FIG. 1A). The tape can be subsequently cut to the desired form factor and covered in release liners. When a manufacturer or other user is ready to utilize the adhesive device, the release liners are removed and the desired components are bonded together by the adhesive device. To remove or separate components from one another, light is optically coupled with the glass carrier via a light source, such as but not limited to a lamp, light box, reflective surfaces, optical fibers, and other devices that can emit light. The photons of light can enter and move through the glass carrier, for example by bouncing or reflecting between an uppermost and a lowermost surface within the glass carrier. During this process, the photons are also absorbed by the adjacent light-releasable adhesive layer, effectively altering the surface energy properties of the light-releasable adhesive layer. After a certain period of time has passed in which a sufficient amount of light absorption has occurred the adhesive properties of the adhesive layer become diminished or disrupted, and bond strength is effectively reduced. The component is then easily and safely removed from the system with minimal effort and minimal impact to surrounding components

In the example shown in FIGS. 1A-IC, the first LDA layer 140 can be understood to include a light de-bondable adhesive, while the first adhesive layer 130 can include any type of adhesive as described earlier. In addition, a first light source 160 emitting light 170 is shown proximate to the first system 100. As light 170 irradiates the first system 100, various outer surfaces of one or more portions of the first system 100 can be exposed to the light 170. For example, different regions along a first side 180 of the first system 100 can receive light 170. In this case, each of the first component 110, the first adhesive layer 120, the first LDA layer 140, and the first substrate 150 include materials that are substantially opaque or do not allow light to pass through. In contrast, the first LTL 130 is configured to allow light to pass through, and includes any substantially transparent material, such as but not limited to glass, plexiglass, clear plastic, polyethylene plastic sheets, clear water, or other light-transmissive materials, as described earlier.

As light reaches an exposed surface 190 associated with the first LTL 130, it can pass through a first end portion (“first end”) 132 and continue to travel along a path 172 through the transmissive material, across a length of the first LTL 130 toward a second end portion (“second end”) 134. In doing so, photons are also absorbed by the layer(s) adjacent to the first LTL 130. In this example, the first LDA layer 140 absorbs light, which effectively alters its surface energy properties. In FIGS. 1A-1C, the LDA layer 140 is disposed between the first substrate 150 and the first LTL 130. In other words, an upper surface 142 of the LDA layer 140 is disposed directly adjacent a lower surface of the first LTL 130, and an opposite-facing lower surface 144 of the LDA layer 140 is disposed directly adjacent an upper surface of the first substrate 150.

In different implementations, the type of LDA and LTA used, as well as the wavelength(s) of light absorbed by the LDA, can affect the configuration in which de-bonding occurs. Referring now to FIGS. 1B and 1C, two possible outcomes of this process are illustrated. As noted above after a particular period of time has passed, the adhesive layer loses its adhesive properties and bond strength is effectively reduced. In FIG. 1B, the lower surface 144 of the first LDA layer 140 has been compromised or degraded following exposure to the light, resulting in loss of adhesion between the lower surface 144 and the first substrate 150. Thus, the first component 110, joined to the first LTL 130 via the first adhesive layer 120, is separated from the substrate layer 150, isolating the first substrate 150 with a removal of a substantial entirety of the first LDA layer 144. In some implementations, a residue associated with the first LDA layer 140 is disposed on a lower surface of the first LTL 130. In contrast, in FIG. 1C, it is the upper surface 142 of the first LDA layer 140 that has been compromised or degraded, resulting in the loss of adhesion between the upper surface 142 and the first LTL 130. Thus, while the general result is the same (where the first component 110, joined to the first LTL 130 via the first adhesive layer 120, is separated from the substrate layer 150) it can be seen that the residue associated with the first LDA layer 140 is now disposed on an upper surface of the first substrate 150 in this case. The reader may appreciate the advantages of a process that can provide a user with flexibility in the specific type of separation they can activate, and allow for the easy and safe removal of the first component 110 from the system with minimal effort and minimal impact to surrounding components. Additional details and examples of this process will be presented below.

Throughout this disclosure, reference will be made to directions or axes that are relative to the adhesive device or various layers of a physical structure or assembly, and/or placement of the adhesive device relative to other layers. For example, the term “distal” refers to a part that is located further from an inner portion of the physical assembly (i.e., is closer to the exterior) or a particular layer of the adhesive device, while the term “proximal” refers to a part that is located closer to the center of the physical assembly (toward the interior, or closer to a center portion). Thus, in FIG. 1A, the first component 110 is distal relative to the first LTL 130. Similarly, the first adhesive layer 120 is distal relative to the first LTL 130 but is proximal relative to the first component 110. In other words, the first adhesive layer 120 can be sandwiched between the LTL and the component. In addition, use of the terms above, upper, below, lower, and other directional terms are made with reference to the physical assembly and adhesive device as oriented in the drawings, and should not in any manner be understood to limit the application(s) of the adhesive device in a physical system.

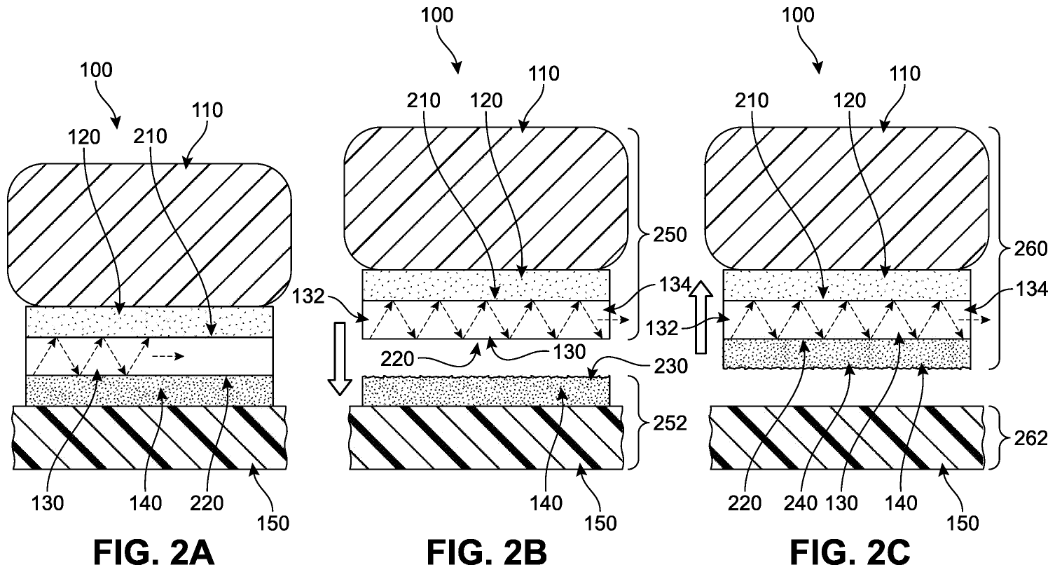

Referring to FIGS. 2A-2C, a magnified view of a portion of the first system 100 is shown. In FIG. 2A, light 170 is beginning to travel through the first LTL 130, from the first end 132 in a direction toward the second end 134. In different implementations, this journey can occur as a result of Total Internal Reflection (TIR), a phenomenon that occurs when light travels from a more optically dense medium (or a medium with a higher refractive index) to a less optically dense one (lower index), such as glass to air or water to air. When light travels from an optically dense medium to a less optically dense medium, the light refracts away from the normal. If the angle of incidence is gradually increased, at a certain point, the refracted ray deviates so far away from the normal that it reflects rather than refracts. This results whenever the refracted angle (predicted by Snell's Law) becomes greater than 90 degrees. The critical angle is defined as the angle of incidence (inside the higher-index material) for which Snell's Law predicts a 90-degree angle of refraction—this would mean the light follows the surface rather than entering the low-index material. This process enables light to be transmitted inside various light-transmissive materials, such as glass fibers. The light is internally reflected off the sides of the glass, and, therefore, follows the path of the glass. This technique can allow light to be transmitted along curves or corners using a glass fiber, provided that the light strikes the sides of the light channel at angles greater than the critical angle. It should be understood that while aspects of TIR are used to propagate the light through the light-transmissive layer(s) in the proposed systems, some degree of refraction or light signal loss can occur, in particular as it is intended that some light be absorbed by neighboring layers as the light travels through the LTL. Thus, the critical angle may not always be the selected angle for the light to be transmitted to the exposed portion of the LTL. In some cases, the angle of incidence can be 20° greater or less than the critical angle.

In FIG. 2A, as light is shone onto the first LTL 130, it first moves upward contacts a transmissive upper surface 210, adjacent to a lower surface of the first adhesive layer 120, and then changes direction to move downward to contact a transmissive lower surface 220, adjacent to the upper surface of the first LDA layer 140. In other words, the arrangement of the light source and the light-transmissive layer allows light to ‘bounce’ or be repeatedly reflected through the length of the first LTL 130, between the transmissive lower surface 220 and the transmissive upper surface 210, as depicted in FIGS. 2B and 2C. In FIG. 2B, a first wavelength of light is configured for absorption by an upper portion 230 of the first LDA layer 140, while in FIG. 2C a second wavelength of light is configured for absorption by a lower portion 240 of the first LDA layer 140. This process of absorption triggers a disruption of the adhesive bonds, as represented schematically by the uneven surfaces in FIGS. 2B and 2C. In FIG. 2B, a first subsystem 250 including the first component 110, the first adhesive layer 120 and the first LTL 130 is separated from a second subsystem 252 including the first substrate 150 and the residual first LDA layer 140. In FIG. 2C, a third subsystem 260 including the first component 110, the first adhesive layer 120, the first LTL 130, and the residual first LDA layer 140 is separated from a fourth subsystem 262 that includes the first substrate 150.

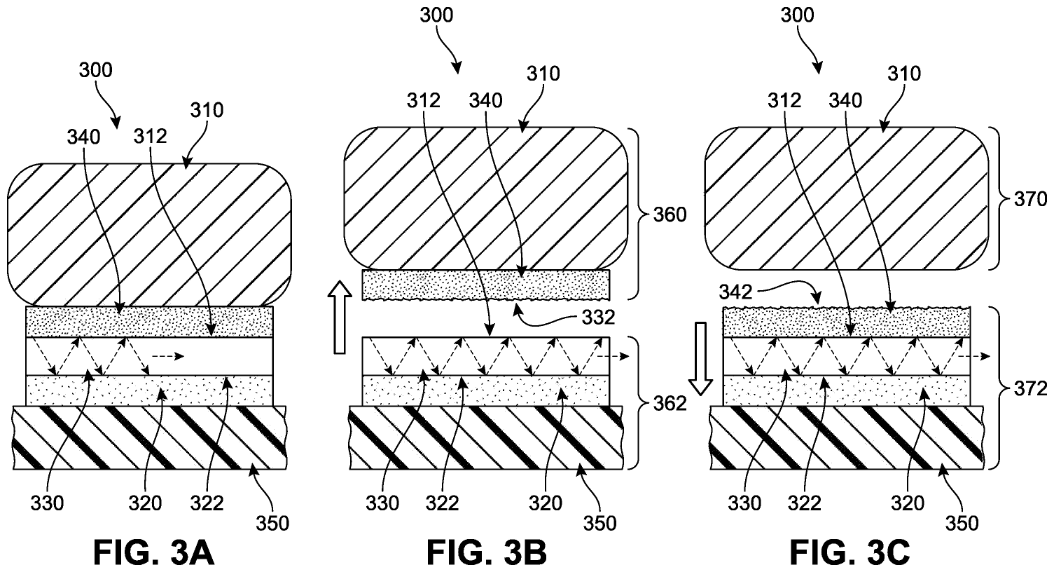

Another example of this technique is shown in FIGS. 3A-3C, where a second system 300 is depicted, including a second component 310, a second LDA layer 340, a second LTL 330, a second adhesive layer 320, and a second substrate 350 is illustrated. In this case, an LTL is again disposed between an adhesive layer and an LDA layer. However, in contrast to the first system 100 of FIGS. 1A-2C, the second adhesive layer 320 is disposed between the lower surface of the second LTL 330 and the upper surface of the second substrate 350, and the second LDA layer 340 is disposed between the upper surface of the second LTL 330 and the lower surface of the second component 310. Thus, as light moves through the second LTL 330, it contacts a transmissive upper surface 312 of the LTL (adjacent to a lower surface of the second LDA layer 340) and then changes direction, to move downward to contact a transmissive lower surface 322 of the LDL (adjacent to the upper surface of the second adhesive layer 320). In FIG. 3B, a third wavelength of light is configured for absorption by a lower portion 332 of the second LDA layer 340, while in FIG. 3C a fourth wavelength of light is configured for absorption by an upper portion 342 of the second LDA layer 340. Absorption triggers a compromise of the adhesive bonds, as represented schematically by the uneven surfaces in FIGS. 3B and 3C. In FIG. 3B, a fifth subsystem 360 including the second component 310 and the residual second LDA layer 340 is separated from a sixth subsystem 362 that includes the second substrate 350, the second adhesive layer 320, and the second LTL 330. In FIG. 3C, a seventh subsystem 370 including only the second component 310 is separated from an eighth subsystem 372 that includes the second substrate 350, the second adhesive layer 320, the second LTL 330, and the residual second LDA layer 340.

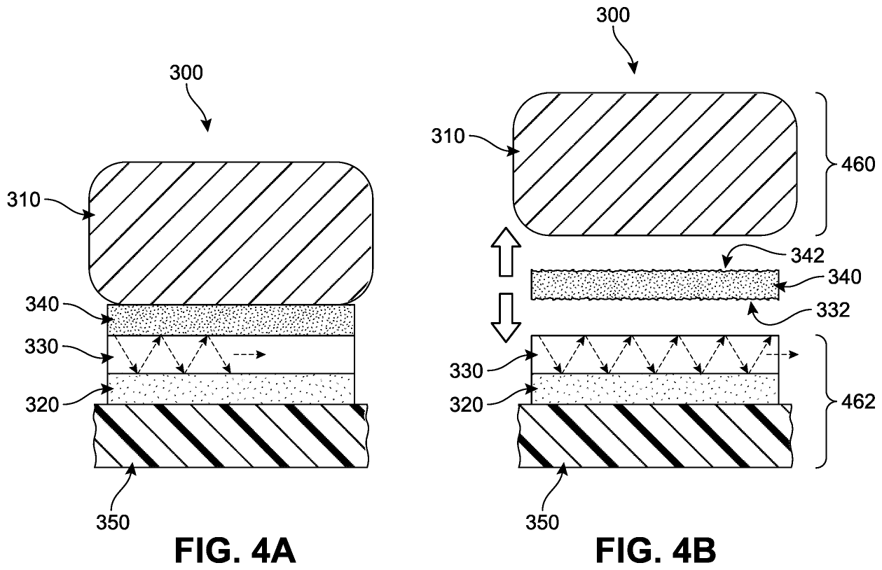

In some implementations, the system can include provisions for separation of each of the various subsystems from the LDA. One example of this technique is shown in the sequence FIGS. 4A and 4B. For purposes of clarity, the second system 300 is again depicted in FIG. 4A. However, the second system 300 is now being exposed to multiple wavelengths of light. In FIG. 4B, a fifth wavelength of light configured for absorption by lower portion 332 of the second LDA layer 340 along with a sixth wavelength of light configured for absorption by upper portion 342 of the second LDA layer 340 are both traveling through the second LTL 330. This dual absorption triggers a disruption of the adhesive bonds on the two opposing surface sides of the LDA, as represented schematically by the uneven surfaces in FIG. 4B. As a result, a ninth subsystem 460 including only the second component 310 is separated from a tenth subsystem 462 that includes the second substrate 350, the second adhesive layer 320, and the second LTL 330. The second LDA layer 340 has been removed along both sides, represented by an isolated view of the second LDA layer 340.

It can be understood that the properties of the LDA that can be applied in a system can vary widely. For example, the thickness of the LDA can range between 10 micrometers and 150 micrometers in different implementations. In one implementation, the LDA thickness can be between 50 micrometers and 90 micrometers, allowing for an effective bonding strength and relatively low impact on the overall system dimensions. Similarly, an LDA itself can vary in shape and size. In some implementations, the material comprising the LDA can extend across an entirety of a component side surface. In one implementation, the LDA may include regions that are curved, contoured, bent, ridged, or textured to better fit, surround, encapsulate, or otherwise cover a portion of a specific component's form factor.

In different implementations, the form factor or area and/or shape(s) of the LDA can also vary. As a first example, an LDA 550 of a second adhesive device 522 can include one or more apertures 510, as illustrated by a third system 500 shown in FIG. 5. Here, the apertures 510 include a first aperture 512, a second aperture 514, a third aperture 516, and a fourth aperture 518. In some implementations, one or more apertures can be shaped, sized and/or arranged in the LDA to correspond to protruding regions in adjacent layers, such as bumps, knobs or other irregularities, or corresponding openings, recesses, or through-holes, in adjacent components or surfaces. Thus, the apertures can vary in shape and size to conform with or accommodate the specific placement, shape, and size of neighboring components for a particular system. In some implementations, the apertures can have a substantially round, square, oblong, rectangular, triangular, polygonal, a rounded polygonal, or other regular or irregular shape. Furthermore, two apertures can differ in size and shape. Such customized, adapted, or specialized regions or irregularities can also facilitate a user's ability to identify the appropriate placement or use of the LDA on a device or in a system.

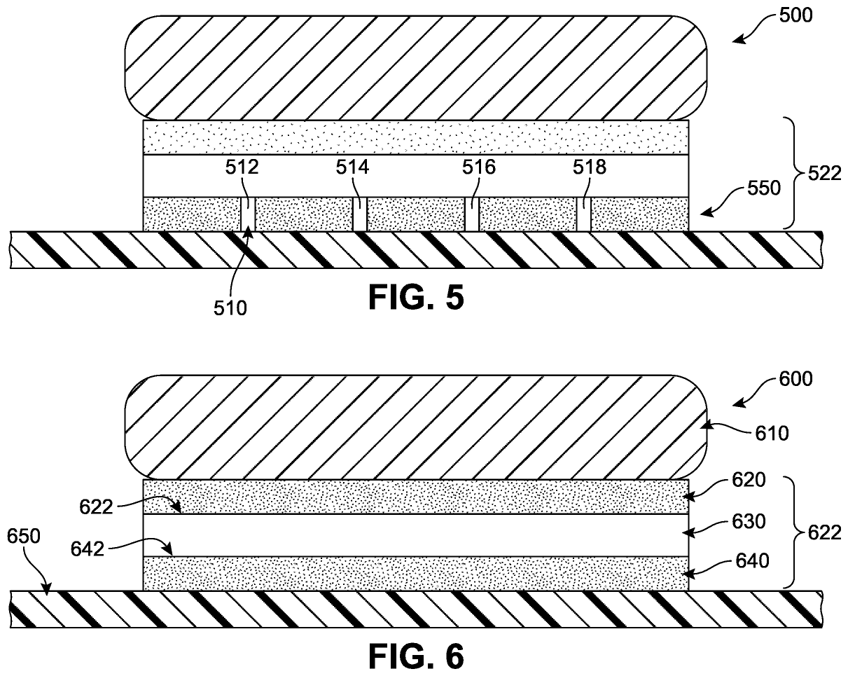

In some cases, as shown in FIG. 4B, the system can offer an option of separating and isolating the component and the substrate (i.e., without either piece remaining attached to the light channel). Some examples of ‘stacking’ arrangements that facilitate this type of isolation of components are shown in FIGS. 6-9.

Referring first to the implementation of FIG. 6, a third system 600 similar in arrangement to the second system of FIGS. 3A-4B is shown. However, in this case, the second adhesive layer of the previous system has been replaced by another light de-bondable layer. In other words, the third system 600 includes a third component 610, a third LDA layer 620, a third LTL 630, a fourth LDA layer 640, and a third substrate 650. In this case, a third adhesive device 622 includes an LTL that is again disposed between two adhesive layers. However, in contrast to the previous systems, both adhesive layers surrounding the LTL are light de-bondable. With this configuration, light can be guided or directed to move through the third LTL 630 as described herein, contacting a transmissive upper surface that is directly adjacent to a lower surface 622 of the third LDA layer 620, and then bounce or reflect downward to contact a transmissive lower surface that is directly adjacent to an upper surface 642 of the fourth LDA layer 640. Thus, the adhesive bonds associated with each of these surfaces (lower surface 650 and upper surface 652) can become compromised as a result of light moving through a single light channel. In addition, as discussed above with respect to FIG. 4B, the two LDA layers can also be exposed to wavelengths of light that result in bonds on both the upper and lower surface of each LDA layer to also or alternatively become compromised.

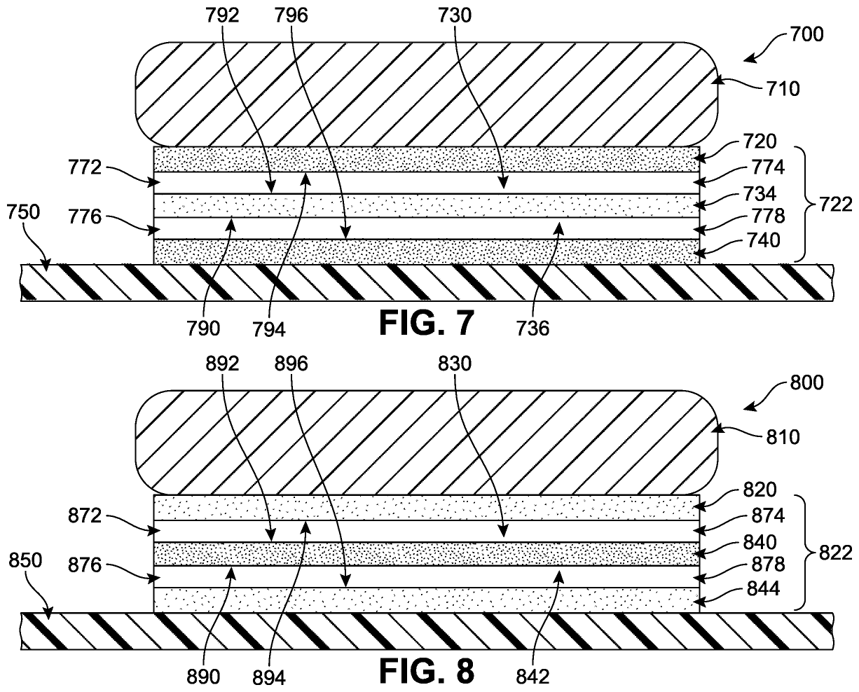

In the implementation of FIG. 7, a fourth system 700 is illustrated, including a fourth component 710, a fifth LDA layer 720, a fourth LTL 730, a third adhesive layer 734, a fifth LTL 736, a sixth LDA layer 740, and a fourth substrate 750. In other words, the fourth system 700 includes a fourth adhesive device 722 with two light de-bondable adhesives and two light channels, arranged in a mirror-image or symmetrical stack with respect to the third adhesive layer 734. In this case, a light source can be directed toward one or both ends of the fourth LTL 730 and fifth LTL 736 as described herein, exposing a first end portion 772 and/or a second end portion 774 of the fourth LTL 730 to light, and/or a third end portion 776 and/or a fourth end portion 778 of the fifth LTL 736. As described above, light can travel through a length of each of these light channels. For example, light can strike a transmissive upper surface of the fourth LTL 730, adjacent to a lower surface 790 of the fifth LDA layer 720, and move downward to contact a transmissive lower surface of the fourth LTL 730, adjacent to an upper surface 792 of the third adhesive layer 734. Similarly, light can strike a transmissive upper surface of the fifth LTL 736, adjacent to a lower surface 794 of the third adhesive layer 734, and move downward to contact a transmissive lower surface of the fifth LTL 736, adjacent to an upper surface 796 of the sixth LDA layer 740. The adhesive bonds associated with each of the LDA surfaces (lower surface 794 and upper surface 796) can be selectively compromised as a result of light being directed through either or both of the light channels.

Another example is provided with reference to a fifth system 800 shown in FIG. 8. The fifth system 800 includes a fifth component 810, a fourth adhesive layer 820, a sixth LTL 830, a seventh LDA layer 840, a seventh LTL 842, a fifth adhesive layer 844, and a fifth substrate 850. In other words, the fifth system 800 includes a fifth adhesive device 822 with two (non-light releasable) adhesive layers and two light channels, arranged in a mirror-image or symmetrical stack with respect to the seventh LDA layer 840. In this case, a light source can be directed toward one or both of the sixth LTL 830 and seventh LTL 842 as described herein, exposing a first end portion 872 and/or a second end portion 874 of the sixth LTL 830 to light, and/or a third end portion 876 and/or a fourth end portion 878 of the seventh LTL 842. As described above, light can travel through a length of each of these light channels. For example, light can strike a transmissive upper surface of the sixth LTL 830, adjacent to a lower surface 890 of the fourth adhesive layer 820, and move downward to contact a transmissive lower surface of the sixth LTL 830, adjacent to an upper surface 892 of the seventh LDA layer 840. Similarly, light can strike a transmissive upper surface of the seventh LTL 842, adjacent to a lower surface 894 of the seventh LDA layer 840, and move downward to contact a transmissive lower surface of the fifth adhesive layer 844, adjacent to an upper surface 896 of the seventh LDA layer 840. The adhesive bonds associated with each of the LDA surfaces (upper surface 892 and lower surface 894) can be selectively compromised as a result of light being directed through either of the light channels.

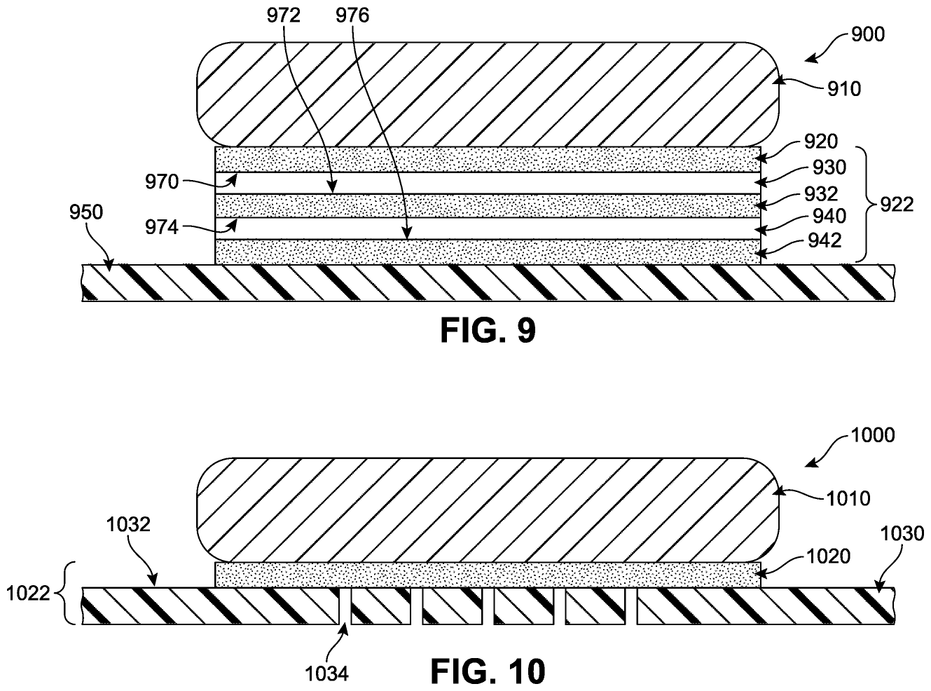

Referring next to the implementation of FIG. 9, a sixth system 900 similar in arrangement to the third system 600 of FIG. 6 is shown. However, in this case, there is a ‘doubling’ of the interior layers. Thus, sixth system 900 includes a sixth component 910, an eighth LDA layer 920, an eighth LTL 930, a ninth LDA layer 932, a ninth LTL 940, a tenth LDA layer 942, and a sixth substrate 950, in a substantially symmetrical arrangement with respect to the ninth LDA layer 932. In this case, a sixth adhesive device 922 includes an LTL disposed between two light de-bondable adhesive layers as well as another LTL also disposed between two light de-bondable adhesive layers. Light can then be directed to move through the eighth LTL 930 as described herein, contacting a transmissive upper surface, adjacent to a lower surface 970 of the eighth LDA layer 920, and then bouncing or reflecting downward to contact a transmissive lower surface, adjacent to an upper surface 972 of the ninth LDA layer 932. The adhesive bonds associated with each of these surfaces (lower surface 970 and upper surface 972) can become compromised as a result of light moving through a first light channel, or only bonds along one surface, depending on the wavelength of light applied. In addition, or alternatively, light can be directed to move through the ninth LTL 940 as described herein, contacting a transmissive upper surface, adjacent to a lower surface 974 of the ninth LDA layer 932, and then bouncing or reflecting downward to contact a transmissive lower surface, adjacent to an upper surface 976 of the tenth LDA layer 942. Thus, the adhesive bonds associated with each of these surfaces (lower surface 974 and upper surface 976) can be disrupted as a result of light moving through a second light channel. Such an arrangement can facilitate the inclusion of additional components in the system that can also be readily removed (e.g., other layers not shown here may be inserted or secured within this type of system).

In different implementations, the proposed systems and methods may include provisions for enabling light to reach the light de-bondable adhesive without the use of a separate or distinct light-transmissive layer. A few examples of this are presented with respect to FIGS. 10-12. In one implementation, the substrate itself may include a means of channeling or guiding light to the light de-bondable adhesive. In FIG. 10, a seventh system 1000 includes a seventh component 1010, an eleventh LDA layer 1020, and a seventh substrate 1030. In some implementations, the light source may be disposed beneath or ‘behind’ the substrate. In other words, a light source may be positioned within the unit or component adjoining or partly enclosed by the substrate or directly adjacent to the substrate. As users are faced with the prospect of disassembly or repair that requires the separation of the component from the substrate, there may in some implementations, be a means of powering and/or activating the light source to initiate the de-bonding process associated with the system. The substrate surface 1032 includes one or more slits, apertures, or openings 1034 configured to allow light to travel through the substrate and reach the LDA layer, thereby compromising the bonds associated with either or both of the surface sides of the LDA and freeing the seventh component 1010 from the seventh substrate 1030. This type of substrate that permits light passage while bonded to an LDA layer is identified as a seventh adhesive device 1022. In other implementations, one or more of the openings 1034 can be filled, coated with, or contain a type of light-transmissive material, allowing light to travel through to the LDA while also maintaining a substantially closed, continuous, or unbroken boundary or environment with respect to the substrate surface.

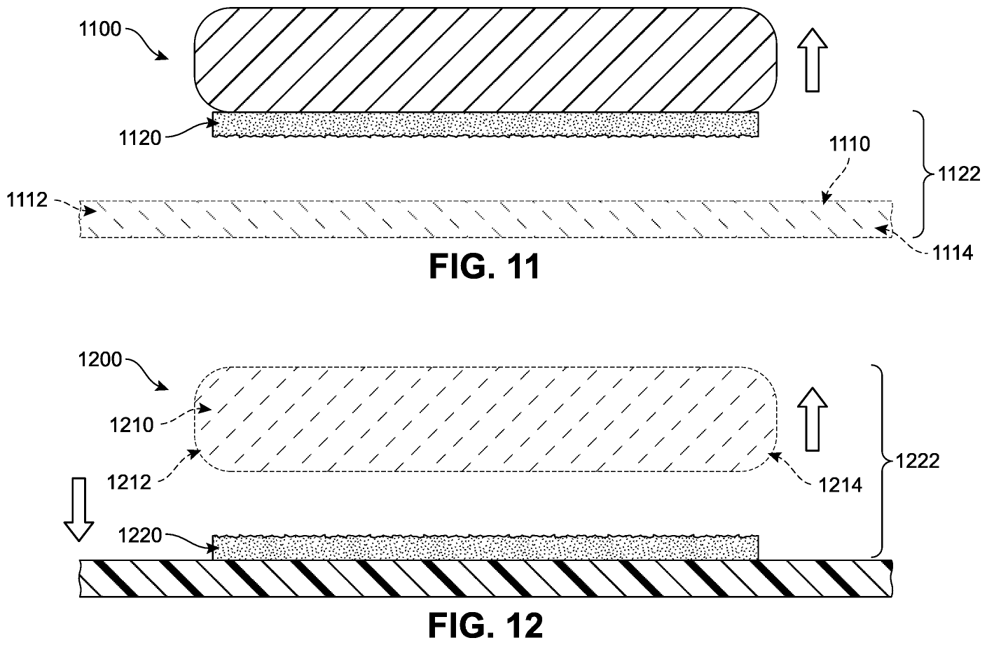

Additional examples of systems that do not include a separate and distinct light-transmissive layer are shown in FIG. 11 with reference to an eighth system 1100 and FIG. 12 with reference to a ninth system 1200. In FIG. 11, it can be seen that an eighth substrate 1110 of the eighth system 1100 is comprised at least in part of substantially transparent or otherwise light-transmissive materials. In other words, a light source may be positioned beneath or ‘behind’ the substrate wall and pass through the transmissive portions of the substrate wall to strike a twelfth LDA layer 1120. Alternatively, a light source can be positioned outside of the unit enclosed by the substrate, and emit a light that travels through a first end portion 1112 and/or a second end portion 1114, bounce and move through a length of the transparent substrate, and be absorbed by the twelfth LDA layer 1120. In other words, the substrate wall itself can serve as both an enclosure barrier or support structure (or other component outer surface) for the system, as well as a light-transmissive layer. This type of arrangement of a substrate and the LDA layer provide an eighth adhesive device 1122.

Similarly, in FIG. 12, a ninth component 1210 of the ninth system 1200 includes at least an outer surface comprised of substantially transparent or otherwise light-transmissive materials. In such a system, a light source may be positioned adjacent to or ‘above’ the component enclosure or housing and pass through the light-transmissive material to strike a thirteenth LDA layer 1220. Alternatively, a light source can be positioned elsewhere relative to the component, and emit a light that travels through a first end portion 1212 and/or a second end portion 1214 of the component's outer wall, bounce and move through a length of the transparent portion, and pass onto the thirteenth LDA layer 1220. In other words, the housing or other external portion associated with the component itself can serve as both an enclosure or support structure for the component, as well function as a light-transmissive layer. Together, the component and the LDA layer provide a ninth adhesive device 1222. These are types of arrangements that can facilitate the process by which the adhesive bonds of the LDA are compromised and allow the ready separation of the component from the substrate without the requirement of a separate LTL.

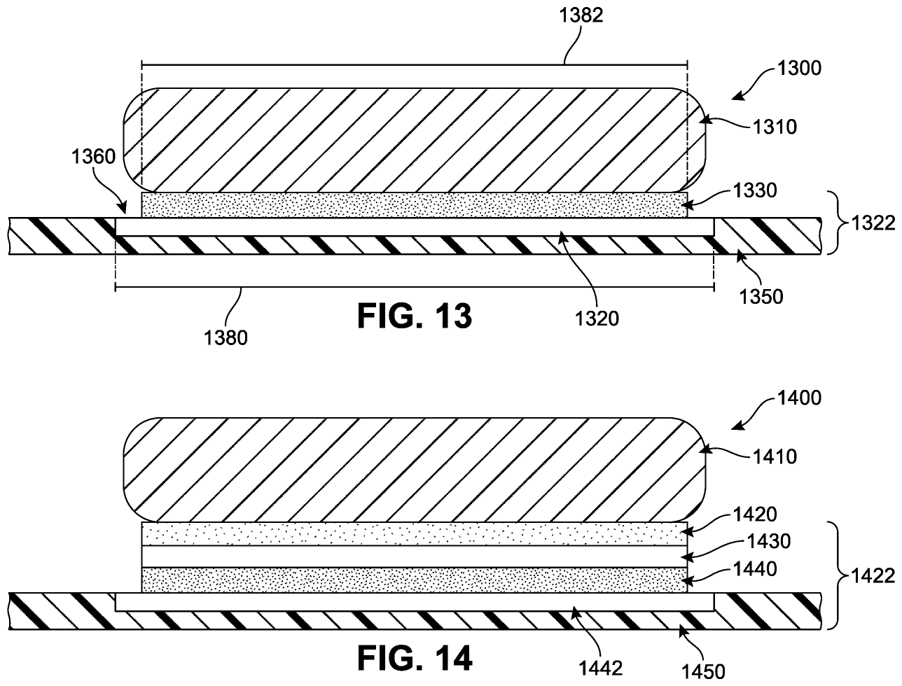

Other implementations can include provisions for minimizing the impact of the LTL thickness or size on the overall structure or dimensions of the system by accommodating or receiving said light channel in the functional layers of the system itself, rather than (or in addition to) the inclusion of a separate and distinct light channel layer. Referring to FIG. 13, a tenth system 1300 with a tenth component 1310, a fourteenth LDA layer 1320, a tenth LTL 1330, and a tenth substrate 1350 to the system is illustrated. In FIG. 13, an adhesive layer is no longer necessary to secure the tenth LTL 1330 and has been removed. Instead, the tenth LTL 1330 is embedded directly within a surface recess 1360 of the tenth substrate 1350, forming a tenth adhesive device 1322 that includes the LDA, the LTL, as well as the recessed portion of the substrate. In other words, in some implementations, the LTL can be secured or disposed within an opening formed in an outer wall of the substrate that is sized and dimensioned to snugly receive the LTL. This can help reduce the overall thickness or dimensions of the system as a result of the removal of both an additional adhesive layer, and the thickness of the LTL that would otherwise extend upward from an outer surface of the substrate. In addition, in different implementations, in order to remain accessible to a light source, the length of the tenth LTL 1330 can be extended beyond the length of at least the adjacent fourteenth LDA layer 1340. Thus, in FIG. 13, a first length 1380 of the tenth LTL 1330 is greater than a second length 1382 of the fourteenth LDA layer 1340. Light can then be directed onto a first exposed region 370 of a first protruding portion 372 and/or a second exposed region 374 of a second protruding portion 376 of the tenth LTL 1330 at the appropriate wavelength and angle to ensure the adjacent LDA layer absorbs light and the bond strength is compromised. It should be understood that the use of protruding portion(s) in the LTL can also be used in any other implementation described herein.

In different implementations, if additional exposure of the LDA layer is desired, the system can include a second LTL disposed between the component and the LDA layer, secured to the component by an adhesive layer. Referring to FIG. 14, an eleventh system 1400 with an eleventh component 1410, a sixth adhesive layer 1420, an eleventh LTL 1430, a fifteenth LDA layer 1440, a twelfth LTL 1442, and a tenth substrate 1450 is shown. To some degree, this system is similar to the fifth system 800 of FIG. 8, which included two light channels, where one light channel was joined to the substrate via an adhesive layer. In this example though, the twelfth LTL 1442 is instead embedded in the substrate, in a manner similar to the tenth system 1300 of FIG. 13, forming an eleventh adhesive device 1422 that includes the LDA, the adhesive layer, both LTLs, as well as the recessed portion of the substrate

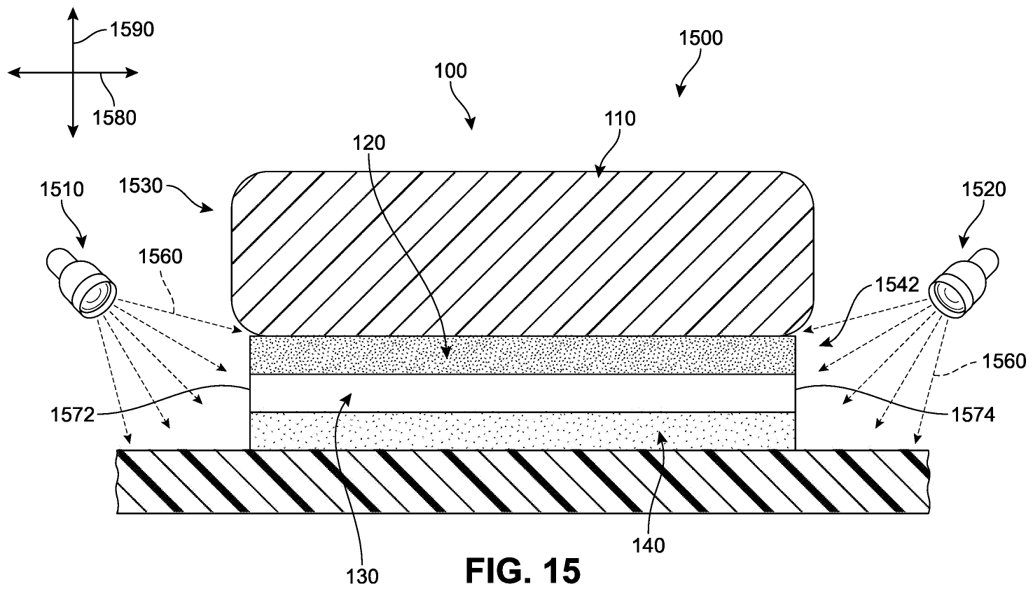

In order to help the reader better appreciate the methods and systems disclosed herein, FIGS. 15-21 present some implementations in which one or more light source(s) are shown. Referring first to FIG. 15, a first light arrangement 1500 is shown in conjunction with the first system 100 (see FIGS. 1 and 2). For purposes of convenience, the systems and light sources in FIGS. 15-21 will be described with reference to a longitudinal axis 1580 and a lateral axis 1590.

In FIG. 15, a first light source 1510 is directed toward a first side portion 1530 of the first system 100 and a second light source 1520 is directed toward a second side portion 1540 of the first system 100. In this example, the side portions of the system include surfaces that are generally aligned with the lateral axis 1590. However, it should be understood that the system drawings are illustrated in simplified or essentially two-dimensional views, and in actual use, a system can be oriented as required by the needs of the functionality and aesthetics of the system. Furthermore, the actual surfaces or sides of the system parts can include any type of bend, texture, bumps, curvature, slant, orientation, or protruding regions. In this example, light 1560 from the first light source 1510 is shown striking a first exposed side 1572 of the first LTL 130, and light 1560 from the second light source 1520 is also shown striking a second exposed side 1574. In this type of arrangement, each light source should be oriented along a variety of angles ranging from 0 degrees (parallel to the lateral axis 1590) to less than 90 degrees, relative to the lateral axis 1590, to ensure that light rays approach the exposed portion of the LTL at the desired angle. FIG. 15 portrays light entering the LTL at approximately 45 degrees, as an example. Light can then travel through the LTL and be absorbed by the adjacent light de-bondable adhesive layer, as described previously. While two light sources are illustrated in FIG. 15, it can be understood that there may be only one light source, or greater than two light sources, in these and other implementations.

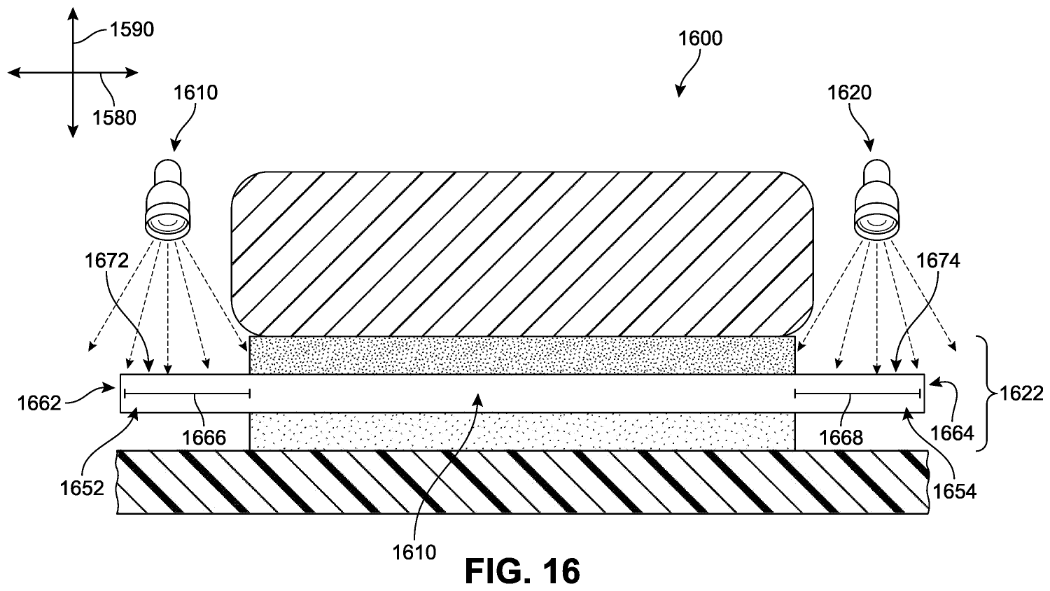

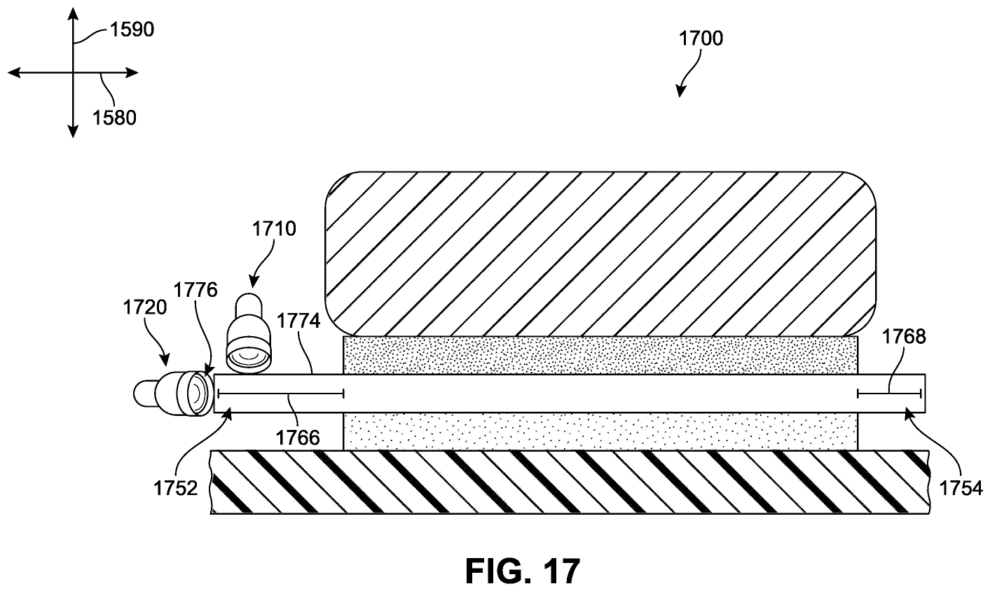

As described above with respect to FIGS. 13 and 14, in some implementations, the systems can include provisions for increasing the surface area of the LTL that is available for receiving light. Some examples of these provisions are presented with reference to FIGS. 16 and 17. In the implementation of FIG. 16, a twelfth system 1600 is shown. The twelfth system 1600 is substantially similar to the first system 100 (see FIGS. 1, 2, and 15) in which an LDA layer is disposed between a component and an LTL, which is further secured to a substrate by an adhesive layer. However, in this case, the side portions of the stacked layers are not flush or even. As shown in FIG. 16, a thirteenth LTL 1610 can have a length greater than one or more of the lengths associated with each of the adhesive layer, the LDA layer, and/or the component. This disparity can result in one or both ends of the LTL to extend, project, or protrude outward relative to other stacked layers of the system (where the stacked layers refer to layers disposed above the substrate). In one implementation, as in FIG. 16, each end of the LTL forms a type of ‘shelf’, such that a first protruding portion 1652 extends outward from a first side 1662 of the twelfth system 1600 by a first distance 1666 and a second protruding portion 1654 extends outward from a second side 1664 by a second distance 1668. These three layers, including the LDA layer, the adhesive layer, and the elongated or extended LTL (relative to the LDA layer and the adhesive layer) will be referred to as a twelfth adhesive device 1622.

With the inclusion of one or more protruding portions, the range of orientations in which a light source may be positioned can be wider than that of FIG. 15. For example, each light source can now be oriented along a variety of angles ranging from 0 degrees (substantially parallel to the lateral axis 1590, as depicted in FIG. 16) to 90 degrees, relative to the lateral axis 1590. In FIG. 16, a first light source 1610 is aimed in a direction that is substantially perpendicular or orthogonal relative to the longitudinal axis 1580, and as a result light rays travel from the first light source 1610 and strike a first exposed upper surface 1672 of the LTL. Similarly, a second light source 1620 is aimed in a direction that is substantially perpendicular relative to the longitudinal axis 1580 on the opposite side of the system, and light rays are shown striking a second exposed upper surface 1674 of the LTL. As a result, light can reflect and travel through the LTL and be absorbed by the adjacent light de-bondable adhesive layer, as described previously.

While first distance 1666 and second distance 1668 can be substantially similar in some implementations (as shown in FIG. 16), in other implementations, there may be only one protruding portion, such that the opposing end is substantially flush with respect to the side of the system. For example, one protruding portion may extend further relative to the other protruding portion, as depicted by a thirteenth system 1700 in FIG. 17. The thirteenth system 1700 is very similar to the system of FIG. 16, in which an LDA layer is disposed between a component and an LTL, which is further secured to a substrate by an adhesive layer. However, in this example, a first protruding portion 1752 extends outward from a first side 1762 by a first distance 1766 and a second protruding portion 1754 extends outward from a second side 1764 by a second distance 1768 that is less than the first distance 1766. This example can also represent the case in which there is only one protruding portion.

As noted above, with the inclusion of one or more protruding portions, the range of orientations in which a light source may be positioned becomes greater. For example, in FIG. 17 a first light source 1710 is a substantially perpendicular or orthogonal relative to the longitudinal axis 1580 and is in fact proximate to or disposed almost directly against an exposed upper surface 1774 of the first protruding portion 1752 of the LTL. Light rays emitted from the first light source 1710 can travel across a thickness of the LTL and be reflected back in a manner described herein to travel through the length of the LTL and compromise the bonds of the LDA layer directly adjacent to the LTL. Furthermore, as an alternative or additional arrangement, a second light source 1720 emits light almost directly into an end surface 1776 of the first protruding portion 1752 of the LTL. Light rays emitted from the second light source 1720 can travel through the length of the LTL and compromise the bonds of the LDA layer directly adjacent to the LTL as described herein.

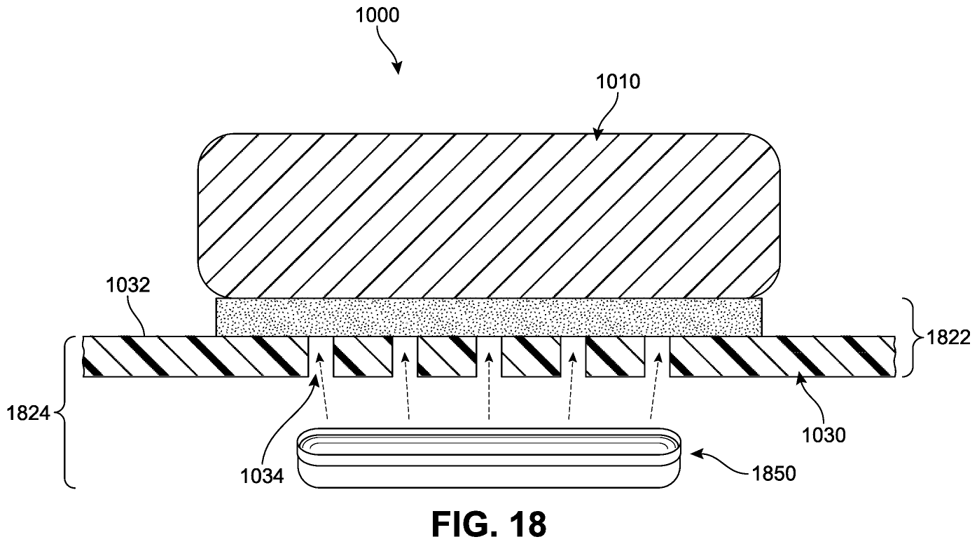

Referring next to FIG. 18, another implementation of a lighting arrangement is shown with respect to the seventh system 1000 (see FIG. 10). As described in FIG. 10, in some implementations, the substrate itself may include a means of channeling or guiding light to the light de-bondable adhesive. In FIG. 18, the seventh system 1000 includes a light source 1850 positioned or disposed beneath or ‘behind’ the substrate. In other words, the light source has been inserted or included within the unit associated with or surrounded by the substrate. Together, these will be referred to as a substrate unit 1824. In this example, the substrate surface 1032 includes one or more slits, apertures, or openings 1034 to allow light to travel through the substrate and reach the LDA layer, thereby compromising the bonds associated with either or both of the surface sides of the LDA and freeing the seventh component 1010 from the seventh substrate 1030. The LDA layer and the apertured substrate together provide a thirteenth adhesive device 1822. In other implementations, one or more of the openings 1034 can be filled, coated with, or contain a type of light-transmissive material, allowing light to travel through to the LDA while also maintaining a substantially closed boundary with respect to the substrate surface.

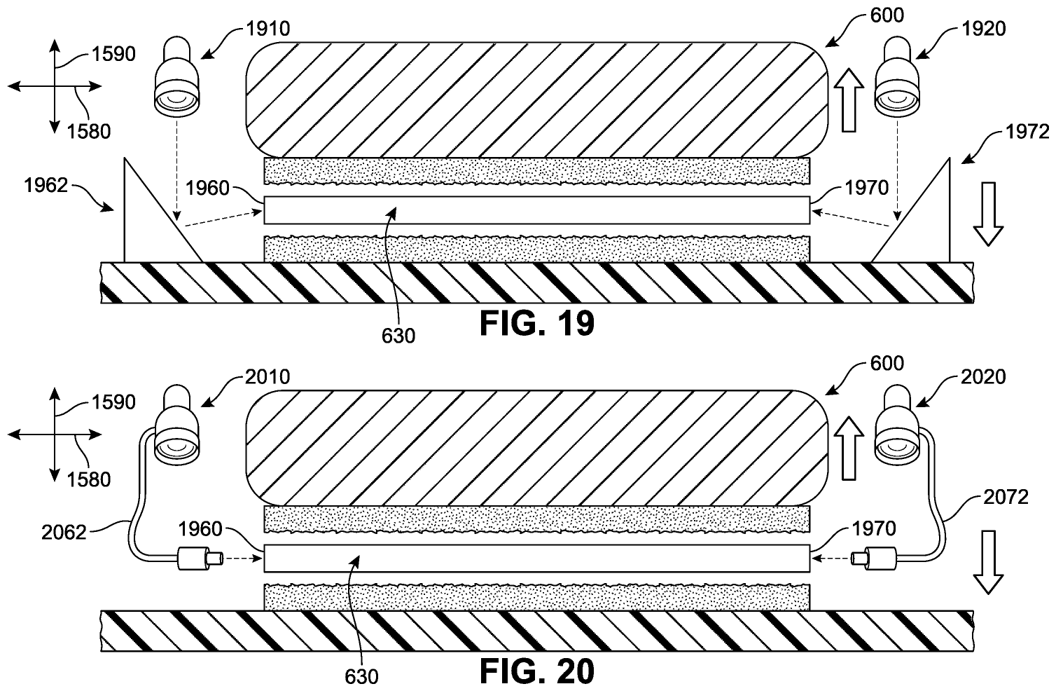

In FIGS. 19, 20 and 21, three examples of light being guided to the LTLs via reflection are presented. In both of FIGS. 19 and 20, the third system 600 (see FIG. 6) is featured for purposes of simplicity, where the third LTL 630 is disposed or ‘sandwiched’ between two adjacent LDA layers, and no protruding portions are available and/or accessible. Thus, the optimal direction for light to approach is along a direction roughly parallel to the longitudinal direction 1580, such that one or both of a first exposed side portion 1960 and a second exposed side portion 1970 of the third LTL 630 can receive light.

In different implementations, the system can include or be disposed in proximity to provisions that can redirect the light as it travels from the light source in order to ensure adequate exposure to the light by the system at the desired location. In FIG. 19, a first light source 1910 is being directed downward, at a generally orthogonal direction relative to the length of the LTL. In order to redirect the light toward the first exposed side portion 1960, a first reflective material 1962 is provided. The first reflective material can include materials that are configured to bounce or reflect light, such as prisms, mirrors, polished metal surfaces, plastic, wax paper, or other shiny, smooth, or other reflective surfaces. The first reflective material 1962 can be oriented at any angle that will redirect the light along a path toward the first exposed side portion 1960 and trigger internal reflection. The angle or slope of the reflective material can vary based on the material used, as well as the location of the reflective material relative to the light source and the LTL. A similar arrangement is presented with respect to a second reflective material 1972, which is positioned such that light from a second light source 1920 is redirected toward the second exposed side portion 1970.

In FIG. 20, a first light source 2010 is also being directed downward, at a generally orthogonal direction relative to the length of the third LTL 630 of the third system 600. In this case, in order to redirect the light toward the first exposed side portion 1960, a first reflective pathway 2062 is provided, such as a cable, tunnel, or tubing, and extends between the first light source 2010 and the first exposed side portion 1960. This pathway can be made of a material that carries light from one end of the pathway to the other, opposite end, including but not limited to fiber optic cables, copper cables, glass tubes, or other means of channeling light to the LTL. This can require the connection or positioning of a cable within the system. In some implementations, such a cable may be pre-inserted into the system at the desired endpoint (i.e., an exposed side portion) and allow a user to readily connect a light source to the other end when needed. The light source(s) can be located at essentially any location in such a scenario, as the cable is flexible and permits a guided or controlled pathway extension for the light to follow. A similar arrangement is presented with respect to a second reflective pathway 2072 and the second exposed side portion 1970.

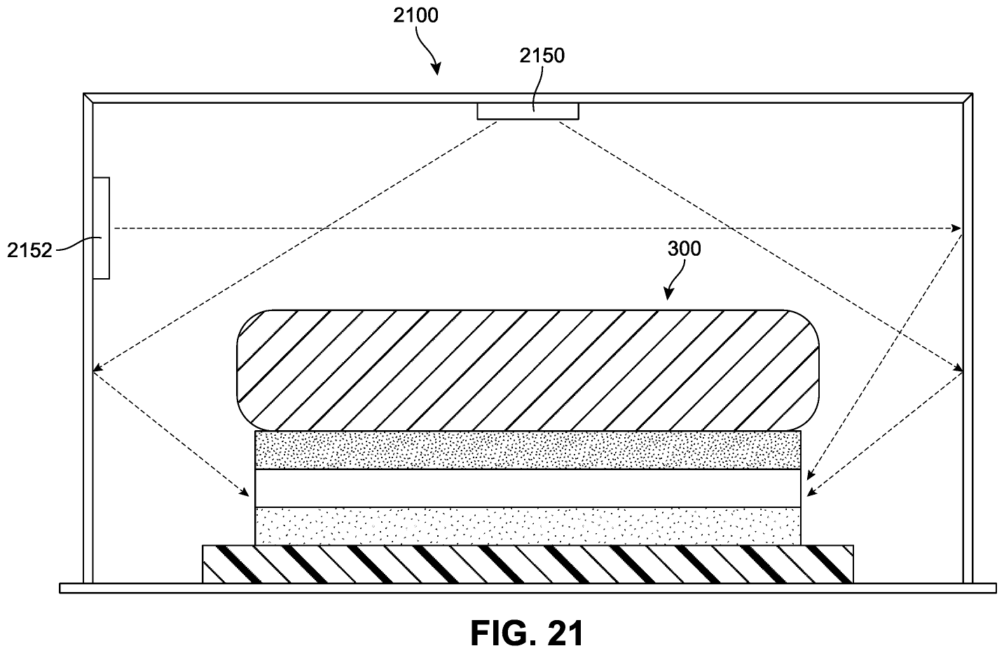

As another example, FIG. 21 presents the second system 300 (see FIGS. 3 and 4) disposed in a substantially enclosed reflective environment (“environment”) 2100. The environment 2100 includes a plurality of sidewalls that are, at least along an interior surface, coated or include a substantially reflective material. As a result, when a first light source 2150 emits light, these rays of light can be reflected or bounce between multiple surfaces, including one or more exposed side portions of the LTL. In some implementations, two or more light sources (see a second light source 2152) can be provided.

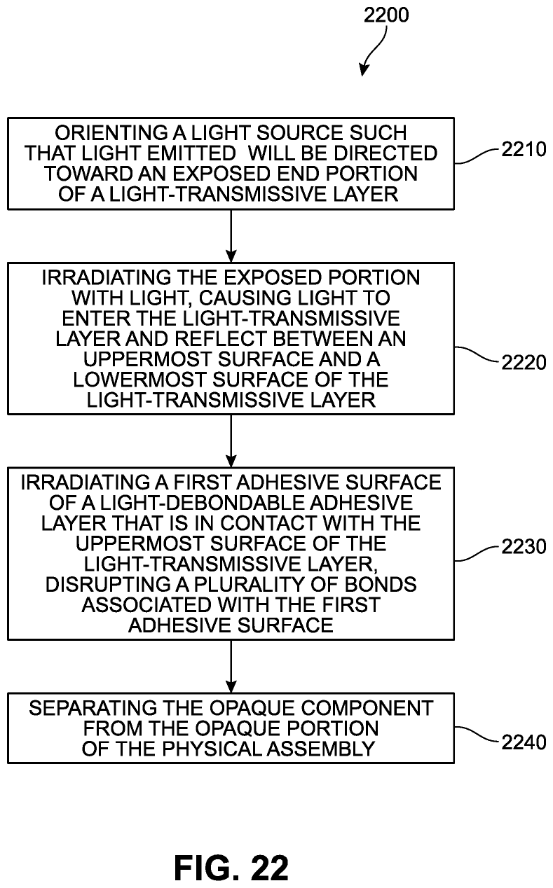

Referring now to FIG. 22, an implementation of a method of removing or separating a component from a physical assembly is presented by reference to a flow chart 2200. It can be appreciated that this method can be configured for use in the removal of an opaque component that is bonded to a portion of a physical assembly by a light de-bondable adhesive device, as described herein. In a first step 2210, the method can include orienting a light source such that light emitted from the light source will be directed toward an exposed end portion of a light-transmissive layer of the light de-bondable adhesive device. The light source can be oriented to ensure at least some light enters the light-transmissive layer at the critical angle for that medium and wavelength of light.

In addition, a second step 2220 includes irradiating (at a particular angle) the exposed portion with light emitted from the light source. This causes light to enter the light-transmissive layer and reflect between an uppermost surface of the light-transmissive layer and a lowermost surface of the light-transmissive layer along a length of the light-transmissive layer. A third step 2230 involves irradiating (as a result of the reflection of light between the uppermost surface and the lowermost surface) a first adhesive surface of a light de-bondable adhesive layer of the light de-bondable adhesive device. Because the first adhesive surface is in contact with the uppermost surface of the light-transmissive layer, a plurality of bonds associated with the first adhesive surface will be disrupted. Finally, a fourth step 2240 includes separating the opaque component from the opaque portion of the physical assembly.

In other implementations, the method can include additional or alternate steps. For example, the method may involve emitting a first wavelength of light via the light source, where the first wavelength is between 10 nm and 400 nm. In some implementations, a second adhesive surface of the light de-bondable adhesive layer is in contact with a surface of the opaque component. In one implementation, the method also includes emitting both a first wavelength of light and a second wavelength of light via the light source. In this case, the first wavelength is configured to disrupt bonds associated with the first adhesive surface and the second wavelength of light is configured to disrupt bonds associated with the second adhesive surface.

In some implementations, the method may further include separating the uppermost surface of the light-transmissive layer from the first adhesive surface, while in other implementations, the method can include separating the opaque component from the second adhesive surface. As another example, the method can include guiding the emitted light from the light source to the exposed portion via a reflective surface that is disposed adjacent to the physical assembly.

For the sake of simplicity of description, details are not provided herein for performing various connection processes and the configuration of different telecommunication components. Implementations of the present disclosure can make use of any of the features, systems, components, devices, and methods described in U.S. Patent Publication Number 2015/0188185 to Taylor et al., published Jul. 2, 2015 and entitled “Reinforcement of battery,”; U.S. Patent Publication Number 2016/0091932 to Dighde et al., published Mar. 31, 2016 and entitled “Computing device bonding assemblies”; U.S. Pat. No. 6,795,137 to Whitted et al., issued Sep. 21, 2004 and entitled “Methods and apparatus for implementing transmissive display devices”; U.S. Pat. No. 9,448,591 to Leong et al., issued Sep. 20, 2016 and entitled “Compliant battery supports for device testing”; and U.S. Pat. No. 8,467,133 to Miller, issued Jun. 6, 2013 and entitled “See-through display with an optical assembly including a wedge-shaped illumination system” as well as each of their disclosed methods and systems, the disclosures of each of which are herein incorporated by reference in their entirety.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

1. A physical assembly comprising:
a first opaque layer and a second opaque layer; and
an adhesive device disposed between the first opaque layer and the second opaque layer, the adhesive device including:
a light-transmissive layer comprising a material that is transmissive to a particular range of light wavelengths, and
a first adhesive layer comprising a light-releasable adhesive, the first adhesive layer being secured to a first surface of the light-transmissive layer.

2. The physical assembly of claim 1, wherein the first adhesive layer bonds the first opaque layer to the light-transmissive layer.

3. The physical assembly of claim 1, wherein the first adhesive layer bonds the second opaque layer to the light-transmissive layer.

4. The physical assembly of claim 1, further comprising a second adhesive layer that includes a pressure-sensitive adhesive.

5. The physical assembly of claim 4, wherein the second adhesive layer bonds the light-transmissive layer to the second opaque layer.

6. The physical assembly of claim 1, wherein adhesive bonds associated with an upper surface of the first adhesive layer are compromised when exposed to a first wavelength of light, and adhesive bonds associated with a lower surface of the first adhesive layer are compromised when exposed to a second wavelength of light, and the first wavelength of light is different from the second wavelength of light.

7. The physical assembly of claim 6, wherein the first wavelength of light is between 10 nm and 400 nm.

8. The physical assembly of claim 1, wherein the light-transmissive layer further comprises a protruding portion that extends distally outward relative to the first opaque layer and the second opaque layer.

9. The physical assembly of claim 1, wherein the second opaque layer is a substrate disposed adjacent to an electronic system.

10. The physical assembly of claim 1, wherein the first opaque layer is an outermost covering of a battery.

11. A physical system comprising:
a first layer that is substantially opaque;
a second layer configured to allow light to pass through the second layer;
a light de-bondable adhesive layer comprising a light-releasable adhesive, wherein a first side of the light de-bondable adhesive layer is bonded to a surface of the first layer and a second side of the light de-bondable adhesive layer is bonded to a surface of the second layer; and
a light source configured to emit light, the light source being positioned such that light emitted by the light source passes through the second layer and contacts the light de-bondable adhesive layer.

12. The physical system of claim 11, wherein the second layer is substantially opaque and includes a plurality of apertures.

13. The physical system of claim 11, wherein the second layer includes a light-transmissive material.

14. A method of removing an opaque component that is bonded to an opaque portion of a physical assembly by a light de-bondable adhesive device, the method comprising:
orienting a light source such that light emitted from the light source will be directed toward an exposed end portion of a light-transmissive layer of the light de-bondable adhesive device;
irradiating the exposed portion with light emitted from the light source, thereby causing light to enter the light-transmissive layer and reflect between an uppermost surface of the light-transmissive layer and a lowermost surface of the light-transmissive layer along a length of the light-transmissive layer;
irradiating, as a result of the reflection of light between the uppermost surface and the lowermost surface, a first adhesive surface of a light de-bondable adhesive layer of the light de-bondable adhesive device, the first adhesive surface being in contact with the uppermost surface of the light-transmissive layer, thereby disrupting a plurality of bonds associated with the first adhesive surface; and
separating the opaque component from the opaque portion of the physical assembly.

15. The method of claim 14, further comprising emitting a first wavelength of light via the light source, wherein the first wavelength is between 10 nm and 400 nm.

16. The method of claim 14, wherein a second adhesive surface of the light de-bondable adhesive layer is in contact with a surface of the opaque component.

17. The method of claim 16, further comprising emitting both a first wavelength of light and a second wavelength of light via the light source, wherein the first wavelength is configured to disrupt bonds associated with the first adhesive surface and the second wavelength of light is configured to disrupt bonds associated with the second adhesive surface.

18. The method of claim 14, further comprising separating the uppermost surface of the light-transmissive layer from the first adhesive surface.

19. The method of claim 17, further comprising separating the opaque component from the second adhesive surface.

20. The method of claim 14, further comprising guiding the emitted light from the light source to the exposed portion via a reflective surface disposed adjacent to the physical assembly.
